(19) United States
(12) Patent Application Publication
(10) Pub. No.: US 2012/0173971 A1
(43) Pub. Date: Jul. 5, 2012

(54) SYSTEM AND METHOD FOR PUBLISHING INFORMATION AND CONTENT

(75) Inventors: Steven Craig Sefton, West Chester, OH (US); Jeffrey Jon Johnson, West Chester, OH (US); Gordon Scott Mindrum, Cincinnati, OH (US)

(73) Assignee: Making Everlasting Memories, LLC, Cincinnati, OH (US)

(21) Appl. No.: 13/416,258

(22) Filed: Mar. 9, 2012

Related U.S. Application Data
(63) Continuation of application No. 11/427,524, filed on Jun. 29, 2006.

(51) Int. Cl. G06F 17/21

(52) U.S. Cl. 715/256

(57) ABSTRACT

A publisher is configured to receive a plurality of inputs such as audio, imagery, text, responses to questionnaires, and the like. The publisher is also operable to access a registry having pre-existing information and content. A user may submit inputs, and may further make selections relating to how the inputs will be processed by the publisher. The publisher is operable to process the inputs in accordance with the user's selections to produce any of a variety of outputs. Outputs of the publisher may include books, sound recordings, newspapers, web pages, movies, prayer cards, collages/montages, and the like. The publisher is also operable to automatically generate a biographical text about a deceased friend or relative of the user, based on inputs and selections provided by the user. The publisher may also provide voice-overs for movies automatically generated using image input, audio input, and selections provided by the user.

### RELATED APPLICATIONS

This application is a continuation of application Ser. No. 11/427,524, filed Jun. 29, 2006, the disclosure of which is incorporated by reference herein.

### BACKGROUND

Information has been gathered, organized, and published in a variety of ways for many years. However, no one prior to the inventors has created or used the invention described in the appended claims.

### BRIEF DESCRIPTION OF THE DRAWINGS

While the specification concludes with claims that particularly point out and distinctly claim the invention, it is believed the present invention will be better understood from the following description taken in conjunction with the accompanying drawings, in which like reference numerals identify the same elements. The drawings and detailed description which follow are intended to be merely illustrative and are not intended to limit the scope of the invention as set forth in the appended claims.

FIG. 1 depicts an exemplary system for gathering and publishing information and content.

FIG. 2 depicts exemplary inputs and outputs of the system of FIG. 1.

FIG. 3 depicts a block diagram showing an exemplary set of steps for gathering and publishing information and content.

### DETAILED DESCRIPTION

The following description should not be used to limit the scope of the present invention. Other examples, features, aspects, embodiments, and advantages of the invention will become apparent to those skilled in the art from the following description, which includes by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive. It should therefore be understood that the inventors contemplate a variety of embodiments that are not explicitly disclosed herein.

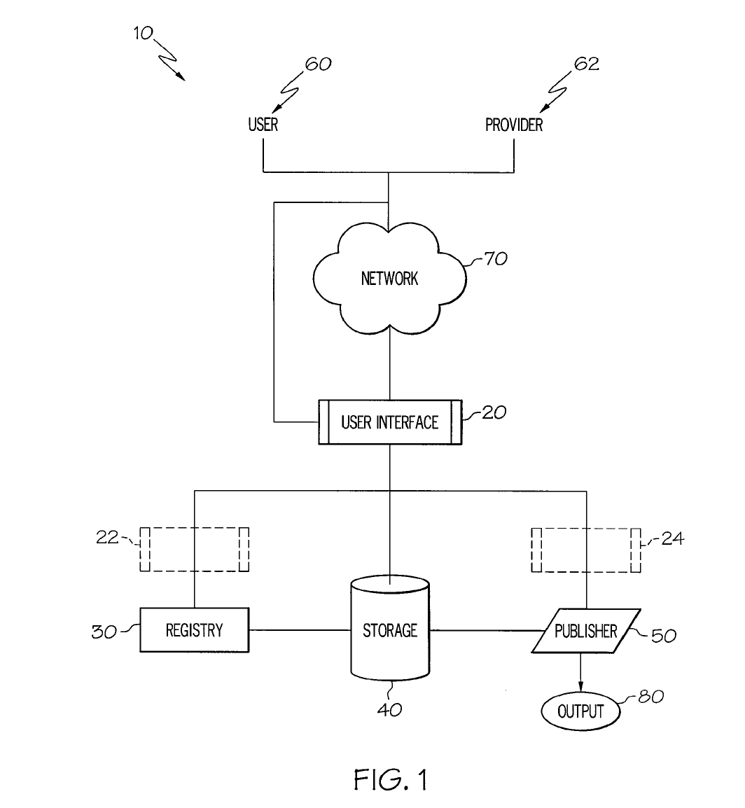

FIG. 1 depicts an exemplary system (10) for gathering and publishing information and content. As used herein, the terms “information” and “content” shall be read interchangeably. As shown, the system (10) comprises a user interface (20), a registry (30), a storage device (40), and a publisher (50). The registry (30) and publisher (50) of the present example are each in communication with storage device (40), though each (30, 50) may alternatively have a respectively dedicated storage device, or the components (3, 40, and 50) may be in any other suitable arrangement. As will be described in further detail below, a user (60) and/or a provider (62) may interact with the system (10) via a network (70). Alternatively, the user (60) and/or provider (62) may interact with the system (10) directly. For instance, the system (10) may reside entirely on a personal computer. In another embodiment, the system (10) comprises a plurality of computers (e.g., servers, clients, etc.). Still other suitable hardware components and configurations for the system (10) will be apparent to those of ordinary skill in the art.

It will be appreciated that a variety of individuals or entities may interact with the system (10) described herein. Such individuals may comprise users (60) and/or providers (62). For instance, the system (10) may be provided, maintained, or otherwise administered by an entity that is regarded as a “service provider.” As used herein, the term “provider” would include such a service provider entity or persons acting on behalf of such an entity. The term “user” would include all other persons who interact with any component of the system (10) (e.g., the registry (30) or the publisher (50)). For instance, the user (60) may be a friend or family member of a deceased person who has an entry in the registry (30). As another example, a user (60) may be a person who is not a “provider,” but is acting on behalf of a friend or family member of a deceased person who has an entry in the registry (30), such as a funeral director. Of course, a person may be a user (60) and a provider (62) at the same time. Other examples of users (60) and providers (62) will be apparent to those of ordinary skill in the art.

In the present example, the registry (30) and publisher (50) are accessible through the same user interface (20). However, it will be appreciated that each (30, 50) may have its own user interface (22, 24). In any event, in the present example, the system (10) is operable to render an output (80) in response to input (90) from the user (60) and/or provider (62).

As shown, the user (60) and/or provider (62) may access the system (10) through a network (70). In one embodiment, the network (70) is the Internet. Alternatively, the network (70) may be any open or closed network, and/or a wide area network (WAN), metropolitan area network (MAN), or a local area network (LAN). Still other exemplary networks (70) will be apparent to those of ordinary skill in the art. In another embodiment, the system (10), or portions thereof (e.g., the publisher (50)), is/are not accessed through a network (70). For instance, the publisher (50) may be provided on a CD-ROM or other computer readable medium, such that it may be operated from the CD-ROM and/or installed on a user's system for operation. In yet another embodiment, the publisher (50) is a program that may be downloaded via a network (70) to a user's system for use thereon. Still other ways in which components of the system (10) may be provided, accessed, and/or operated will be apparent to those of ordinary skill in the art.

The storage device (40) of the present example comprises a server that is remote from users (60), who are permitted to access the registry (30) on-line. Of course, the storage device (40) may comprise any other type of device(s), including but not limited to a local hard drive, and may be located locally and/or remotely from the user (60). The storage device (40) may thus comprise any number of devices in any of a variety of locations.

The storage device (40) may store, among other things, information relating to entities, events, places, objects, and/or any other type of subject(s), including combinations thereof. Examples of various types subjects will be discussed in greater detail below.

Where several different entries may be made for a particular subject, the term “subject item” as used herein shall be understood to refer to a discrete item of subject matter within that particular subject. A subject item may thus be “created” or otherwise established when the first entry of information is made for a discrete item of subject matter. For instance, if a subject is entities, a subject item may be a particular entity. The particular entity may be established as a subject item when the first entry of information is made for that entity. In this example, a plurality of information entries may be stored in the storage device (40) for each such entity. As another example, where the subject is places, a subject item may be a particular location; and a plurality of information entries may be stored in the storage device (40) for each such location. It will therefore be appreciated that a subject may have a plurality of associated subject items; and each subject item may have a plurality of associated information entries. It will also be appreciated that a given information entry may be associated with a plurality of subject items, if not a plurality of subjects. Furthermore, it will be appreciated that the storage device (40) may also store generic or “stock” information entries, which are not necessarily predeterminedly associated with a particular subject item and/or subject.

In one embodiment, the registry (30) includes information relating to a plurality of entities. For instance, the entities may comprise businesses, organizations, associations, living persons, deceased persons, pets, a group, and the like, including combinations thereof. Other entities will be apparent to those of ordinary skill in the art. In one example of this embodiment, the registry (30) includes biographical information and tributes relating to a plurality of deceased persons. Where the entity is a person, biographical information on the registry (30) may include, but need not be limited to, accomplishments by an individual, genealogical information, medical information, military service, where an individual was born, where an individual has worked, etc. Tributes may include, but need not be limited to, eulogies, stories by families and friends about a deceased individual, statements for or to a deceased individual, etc. It will be appreciated that a tribute may also include biographical information. Accordingly, the present applicants do not intend that the terms “tribute” and “biographical information” be necessarily considered mutually exclusive. Other information suitable for including in the registry (30) will be apparent to those of ordinary skill in the art.

In another embodiment, the registry (30) includes information relating to a plurality of events. For instance, the events may comprise weddings, proms, graduations, bar mitzvahs, confirmations, retirement parties, vacations, fairs, carnivals, air shows, circuses, festivals, concerts, a sporting event, conventions, and the like. An event may also comprise a historic moment in time (e.g., the civil war). Other events will be apparent to those of ordinary skill in the art. It will also be appreciated that the registry (30) may include information relating to both entities and events, among other things.

In yet another embodiment, the registry (30) includes information relating to places and/or objects. For instance, the registry (30) may include information relating to a historic landmark or site, an artifact, a city, or any other type of place or object. Other places and objects will be apparent to those of ordinary skill in the art.

In the present example, the network (70) comprises the Internet, and each subject item in the registry (30) has a respective dedicated web page or series of dedicated web pages that are accessible over the Internet. The registry (30) is accessible through a user interface (20 or 22). The user interface (20 or 22) may include a home page that includes a search engine, listing, or other device permitting users (60) to find information relating to a particular subject item in the registry (30). Of course, the home page may include hyperlinks, applets, or other features for invoking a search engine or similar devices. Other ways in which subject items may be presented to, searchable by, and/or selectable by a user (60) will be apparent to those of ordinary skill in the art, as will variations of network (70).

The registry (30) may also request some form of identification for a user (60). For instance, a first-time user (60) may be asked to create a username and password, such that returning users (60) are asked to “log in” to the registry (30). Thus, it will be appreciated that a user (60) may establish an association with the registry (30). With an association so established, it will be appreciated that subjects, subject items, and/or entries of information in the registry (30) may be associated with a given user (60). Such an association may be established in a variety of ways. For instance, where a user (60) submits an information entry for the registry (30), that information entry may be associated with the submitting user (60). As another example, where a user (60) creates a subject item (e.g., creates a first entry for a deceased relative of the user (60)), that subject item may be associated with the creating user (60). In addition, or in the alternative, where a user (60) accesses a subject, subject item, and/or entry of information, an association may be created between the user (60) and the thing(s) accessed by the user (60).

In another embodiment, a user (60) must actively create an association between the user (60) and a subject, subject item, and/or entry of information. For instance, the user (60) may be required to create a listing, check a box, click a radio button, or perform some other dedicated act to create an association between that user (60) and a particular subject, subject item, and/or entry of information. A user (60) may establish an analog to a “my favorites” listing of associated subjects, subject items, and/or entries of information, which can be quickly accessed upon a subsequent visit by the user (60) to the registry (30). The user (60) may also create an association between another user (60) and a subject, subject item, and/or entry of information. For instance, where a user (60) creates an entry of a deceased relative as a subject item, the user (60) may designate several other living relatives as users (60) to be associated with the deceased relative's subject item entry. Still other ways in which associations may be established between users (60) and subjects, subject items, and/or information entries will be apparent to those of ordinary skill in the art.

To the extent that the registry (30) employs a “log in” type of device, it will be appreciated that such a device may be implemented in a variety of ways. For instance, all users (60) may be required to log in to obtain access to the registry (30). In this embodiment, a listing, dedicated home page, or other user-specific item may be called up after the registry (30) processes the user's (60) log in information. By way of example only, after receiving a user's (60) log in information, the registry (30) may provide a listing to the user (60) of all subject items associated with the user (60). Alternatively, a log in may be required for a user (60) to create a subject item in the registry (30). Alternatively, a log in may be required only for a user (60) to submit information relating to a subject or subject item. In another embodiment, information relating to a subject item is subject to varying or tiered security levels, such that a log in is required to gain access to some information, while a log in is not required to gain access to other information. Still other ways in which a log in feature may be employed with the registry (30) will be apparent to those of ordinary skill in the art.

The registry (30) of the present example is on-line, and includes information relating to a plurality of deceased persons. In this embodiment, the storage device (40) comprises a server that is remote from users (60) who access the registry (30) on-line. The storage device (40) stores, among other things, the information (e.g., biographical information, tributes, etc.) relating to the deceased persons. In the present example, the network (70) comprises the Internet, and each deceased person in the registry (30) has a respective dedicated web page or series of dedicated web pages (e.g., as a web site) that are accessible over the Internet. Alternatively, a given web page of the registry (30) may include information relating to a plurality of deceased persons. It will also be appreciated that, where each deceased person in the registry (30) has at least one respective dedicated web page or web site, the web pages and/or web sites for a plurality of deceased person may share a common domain name or domain name portion.

The registry (30) of the present example is accessible through a user interface (20 or 22). The user interface (20 or 22) may include a home page that has a search engine, listing, or other device permitting users (60) to find information relating to a particular person in the registry (30). Of course, the home page may include hyperlinks, applets, or other features for invoking a search engine or similar devices.

By way of example only, the registry (30) may comprise a system such as any of those described in U.S. Non-Provisional patent application Ser. No. 09/829,863, filed Apr. 10, 2001, the specification and drawings of which are incorporated by reference herein for non-limiting, illustrative purposes only.

In the present example, the web page(s) in the registry (30) for each deceased person comprise(s) biographical information and/or tributes relating to the respective deceased person. It will be appreciated that such biographical information and/or tributes may be collected and/or presented in a variety of forms, including but not limited to text, audio, video, still images, and combinations thereof. It will also be appreciated that biographical information, tributes, or any other input may undergo a manual or automated change in form from the time it is submitted by a user (60) to the time it is presented to the user (60) or someone else. By way of example only, contents of the registry (30) may comprise data and recordations such as those described in U.S. Pat. No. 6,340,978, the specification and drawings of which are incorporated by reference herein for non-limiting, illustrative purposes only. As another example, the registry (30) may include one or more commemorative presentation features such as those described in U.S. Patent App. Pub. No. 2003/0197721, the specification and drawings of which are incorporated by reference herein for non-limiting, illustrative purposes only. Similarly, as will be discussed in greater detail below, a publisher (50) may be operable to produce commemorative presentations such as those described in U.S. Patent App. Pub. No. 2003/0197721.

In another embodiment, the registry (30) includes information relating to a plurality of living persons, such as students and/or children. Such information may include, by way of example only, school pictures (e.g., individual, group, and miscellaneous), family photos from home, school projects and artwork, messages (e.g., written or audio) from classmates and teachers, and general historical and personal data. This information may be compiled and/or produced periodically (e.g., annually), and accumulated on computer systems each year as a student grows.

It will also be appreciated that subject items in the registry (30) may be linked with one another. By way of example only, where the registry includes information relating to a plurality of living and/or deceased members of a particular family, a web page for a given member of that family having related information on the registry (30) may be linked to a web page for another member of that family having related information on the registry (30). For instance, a web page of the registry (30) for a deceased uncle may include links to web pages of the registry (30) for living nieces and nephews. Such linking may be established automatically (e.g., in response to data input into one or more particular fields), manually (e.g., pursuant to explicit user (60) request), or both. Still other ways in which subjects and/or subject items in the registry (30) may be linked will be apparent to those of ordinary skill in the art.

While several variations of the registry (30) have been described above, it will be appreciated that the registry (30) may be further subject to variation, modification, substitution, and supplementation. It will also be appreciated that some embodiments may lack a registry (30) altogether. Still other embodiments will be apparent to those of ordinary skill in the art.

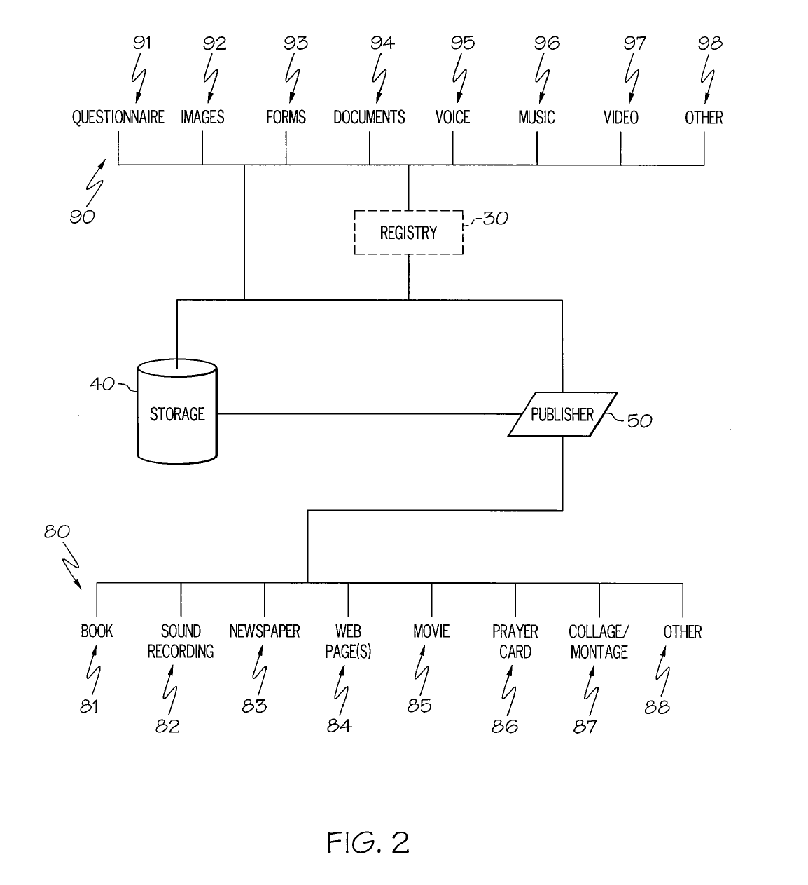

As shown in FIG. 2, the publisher (50) of the present example is operable to process inputs (90) of various formats. Using data, information, content, and the like that is received as inputs (90), and/or possibly using the same from other sources (e.g., stock data, stock information, stock content, etc.), the publisher (50) of the present example is operable to render any of a plurality of outputs (90) in accordance with user (60) selections and configurations. By way of example only, inputs (90) may comprise responses to a questionnaire (91), images (92), completed forms (93), documents (94) of any type, voice (95), music (96), video (97), and/or any other (98) form or type of input (90), including combinations thereof.

The exemplary inputs (90) shown in FIG. 2 are not intended to be exhaustive. Additional inputs (90) or sources of the same may include, but are certainly not limited to, any of the following: web log (a.k.a. “blog”) data; “podcasts,” such as those associated with Apple's IPOD device; streaming video of funerals; other streaming data; voice over internet protocol (VoIP) transmissions; data entries made at a kiosk located at a cemetery or elsewhere; works of art or other authorship; awards, certificates, and the like; published works; patents or evidence of other accomplishments; wills, trusts, and the like; tax records or other financial records; and/or insurance inventories. Inputs (90) may also be “pulled” automatically. For instance, an input (90) may comprise information pulled from websites, such as geneology websites, including data pulled from such websites using spiders, bots, scrapers, and the like. As another merely illustrative example, an input (90) may comprise a database that includes information associated with a particular date or time period in history. For instance, such a database may comprise information relating to the price of bread, the average price of a home, births/deaths of historical figures, significant historical events, etc., associated with a particular date or time period. Information from such a “on this date in history” database may be pulled automatically based upon a date entry made by a user (60), and provided as an input (90). For instance, where a subject item is a deceased person, and a user (60) enters the date that the deceased person was born on, “on this date in history” information associated with that “born on” date may be pulled automatically from a database and entered as input (90). Still other suitable inputs (90), sources of inputs (90), and methods of obtaining information from such sources, will be apparent to those of ordinary skill in the art. It will also be appreciated that any of the foregoing inputs (90) may be used for putting information into the registry (30) as well.

Exemplary outputs (80) of the publisher (50) include, but are certainly not limited to, books (81), sound recordings (82), newspaper articles (83), web pages (84), movies (85), prayer cards (86), collages/montages (87), and/or any other (88) form or type of output (80), including combinations thereof. These exemplary outputs (80), among others, will be described in greater detail below.

As with the registry (30), the publisher (50) may be implemented on-line, and may be accessible to users (60) via the Internet. Similarly, the publisher (50) may include a “log in” procedure for users (60), such as with a username and password, and may further include a tiered security feature. Each user (60) may also create a profile for the publisher (50) in which preferences, prior inputs (90) submitted by the user (60), outputs (80) created for the user (60), and other user-related information may be kept for and accessed by the user (60) and/or publisher (50).

Inputs (90) may be put into the publisher (50) directly by a user (60). It will also be appreciated that inputs (90) may be stored in a storage device (40). Alternatively or additionally, inputs (90) may be communicated from a storage device (40) to publisher (50). Alternatively or additionally, inputs (90) may be communicated from the registry (30) to the publisher (50). Inputs (90) may also be communicated to the publisher (50) by a provider (62). Other ways in which inputs (90) may be communicated to publisher (50) will be apparent to those of ordinary skill in the art.

As noted above, the publisher (50) may employ the use of questionnaires (91) for an input (90). In one embodiment, a questionnaire (91) comprises questions for a user (60) to answer about a subject item such as a deceased person. For instance, the questionnaire (91) may present questions to the user (60) asking for certain biographical information or tributes for a deceased relative of the user (60). The questionnaire (91) may be configured to receive responses to the questions in a variety of forms, including but not limited to text responses, radio buttons, multiple choice checkboxes, drag and drop devices, or any other form of response, including combinations thereof. The user's responses to the questionnaire (91) may thus be used as an input (90) for publisher (50).

It will also be appreciated that a user's responses to a questionnaire (91) may be used by the publisher (50) to present one or more additional questionnaires (91) to the user (60). For instance, certain questions in a questionnaire (91) may have a finite number of possible answers (e.g., either “yes” or “no”). Each of those possible answers may raise a host of other “follow up” questions, such that entry of a particular answer by the user (60) may trigger an association with another questionnaire (91) having those follow up questions. The publisher (50) may present the associated additional questionnaire (91) to the user (60) as soon as the triggering answer is received, after the user (60) completes the first questionnaire (91), or at any other suitable time. Other ways in which questionnaires (91) may be related to each other will be apparent to those of ordinary skill in the art.

To the extent that questionnaires (91) are used to provide an input (90) for the publisher (50), it will be appreciated that a variety of types of questionnaires (91) may be used. For instance, questionnaires (91) may vary in terms of questions asked or length. Questionnaires (91) may also vary in terms of desired response forms. Other ways in which questionnaires (91) may vary will be apparent to those of ordinary skill in the art. Where a variety of types of questionnaires (91) are used, a determination may be made as to which type of questionnaire (91) to present to the user (60). In one embodiment, the type of questionnaire (91) is selected by the user (60). For instance, the questionnaire (91) that is used may be selected by the user (60) from a listing that shows the available questionnaire types. In another embodiment, the type of questionnaire (91) is selected at random. In yet another embodiment, the type of questionnaire (91) is selected based on a user's selection of another variable publisher (50) feature, as will be described in greater detail below. Other ways in which a questionnaire (91) may be selected will be apparent to those of ordinary skill in the art.

In one embodiment, questionnaires (91) are presented to users (60) via the network (70). For instance, the questionnaires (91) may be presented as web pages, applets, or any other device via the Internet or other network. In another embodiment, questionnaires (91) are presented to users (60) as a hard copy (e.g., on paper). In yet another embodiment, questionnaires (91) are presented to users (60) via a telephone (e.g., via a call center agent and/or an interactive voice response (IVR) device). In still another embodiment, questionnaires (91) are presented to users (60) using cellular technology and/or portable digital assistant devices (PDAs) or the like. Any other suitable technique for presenting questionnaires (91) to users (60) may be used.

Just as the forms and methods for presenting questionnaires (91) to users (60) may vary, so may the forms and methods for receiving responses to questionnaires (91) from users (60). For instance, where a questionnaire (91) comprises a web page, the user (60) may provide responses via the web page. Where a hard copy questionnaire (91) is presented to a user (60), a response may be provided in hard copy form. Where responses are provided in hard copy form, those responses may be entered into publisher (50) manually (e.g., by data entry personnel) and/or automatically (e.g., via optical scan, OCR conversion, etc.). It will therefore be appreciated that the method of presenting questionnaires (91) to users (60) need not parallel the method of receiving responses to those questionnaires (91), nor the method of entering such responses as input (90) to the publisher (50). Of course, any other forms and methods for presenting questionnaires (91) to users (60), receiving responses from users (60), and providing such responses as input (90) for the publisher (50) may be used.

As noted above, the publisher (50) may also receive images (92) as an input (90). The images (92) may include, but need not be limited to, photos, sketches, graphic designs, and the like. Such images (92) may be received from a user (60) electronically via the network (70) (e.g., as a JPEG file or any other type of file, or in any other type of image format, transmitted from the user's computer). Alternatively, images (92) may be received from a user (60) as a hard copy (e.g., as a printed photograph). Such hard copy images (92) may be entered into the publisher (50) through conversion to electronic form, such as by scanning. Alternatively, images (92) may be entered into the publisher (90) in any other suitable way.

It will also be appreciated that the publisher (50) may have a plurality of pre-existing images (92) (e.g., stock photos or graphic designs, etc.), such that the user (60) is permitted to select from the pre-existing images (92). In such an embodiment, the user's selection of pre-existing images (92) may constitute an input (90) into the publisher (50). A user (60) may further be permitted to submit a caption or other information, in text, audio, or any other form, relating to each image (92) submitted or selected as an input (90).

Forms (93) may be used to provide input (90) for the publisher (50) in a manner similar to questionnaires (91). For instance, a variety of types of forms (93) may be presented to the user (60) using any suitable technique, and the user (60) may submit completed forms (93) using any suitable technique. Such forms (93) may be configured to elicit information about the user (60) and/or about the subject item (e.g., a deceased friend or relative of the user (60)).

Documents (94) may be also used to provide input (90) to publisher (50) in a variety of ways. Such documents (94) may comprise information relating to a subject item. It will be appreciated that in some instances, a document (94) itself may be of relevance (e.g., a diploma or award), such that an image of the document (94) would be desired; while in other instances the contents of a document (94) are what is relevant. In one embodiment, the user (60) transmits a copy of a document (94) to the publisher (50) in electronic form via the network (70). For instance, the document (94) may be scanned by the user (60) and submitted as an image or .pdf file, etc. In another embodiment, the user (60) sends a hard copy of a document (94). Where a hard copy of a document (94) is submitted, the document (94) may be scanned by data entry personnel and electronically entered into the publisher (50) as an image, an OCR converted electronic document, or otherwise. Alternatively, contents of the document (94) may be entered into the publisher (50) by data entry personnel via transcription. Still other ways in which documents (94) may be used as an input (90) for the publisher (50) will be apparent to those of ordinary skill in the art.

Voice (95) may also be used as an input (90) for the publisher (50). The voice (95) may be that of the user (60) (e.g., discussing the subject item, paying tribute to the subject item, etc.), the voice (95) of a subject item (e.g., a pre-recorded statement by a now-deceased individual), and/or the voice (95) of someone else (e.g., a person reading a script prepared by the user (60), a script prepared for the user (60), or a script selected by the user (60), etc.). Of course, any other source for a voice (95) may be used.

In one embodiment, voice (95) is submitted by the user (60) via a telephone (e.g. using POTS technology, using VoIP technology, etc.). For instance, the publisher (50) may include or be in communication with an interactive voice response (IVR) device that is operable to receive voice (95) from a user (60) via a telephone and electronically route and/or tag the voice (95) input (90) appropriately. Such an IVR may prompt a user (60) to enter a code that is associated with the user (60), that is associated with a subject item in the registry (30), and/or that is of some other relevance, then prompt the user (60) to enter his/her voice (95) (e.g., after a tone). Alternatively, the code or other identifier may be entered after the voice (95) is entered. To the extent that the voice (95) relates to a subject item in an on-line version of the registry (30), the audio of the voice (95) may be automatically posted to a web page for that subject item in the registry (30). An IVR device may also be configured to receive any number of publisher (50) configurations and selections from a user (60). For instance, a user (60) may select a particular type of output (80), a manner in which voice (95) input (90) should be implemented into an output (80), and/or make any other configuration selections or preference indications relating to the publisher (50) and/or the registry (30) via an IVR device. Other ways for implementing an IVR device into the system (10) or otherwise receiving voice (95) via a telephone will be apparent to those of ordinary skill in the art.

In another embodiment, voice (95) is transmitted to the publisher (50) via the network (70) as an audio file (e.g., a .wav file). For instance, an audio file comprising voice (95) may be uploaded from the user's computer to the publisher (50). In yet another embodiment, voice (95) is submitted in hard copy form (e.g., on a tape or CD, etc.) and electronically entered into the publisher (50). Of course, voice (95) may be submitted to or entered into the publisher (50) in any other suitable way.

As another variation, a voice (95) input (90) may comprise audio recorded at a deceased person's funeral. Such recordations may include, but need not be limited to, a eulogy, interviews with funeral attendees, or other statements by funeral attendees, and/or any other audio. By way of example only, a provider (62) may have personnel attend funerals to conduct such interviews or otherwise gather audio to provide as an input (90) to the publisher (50).

To the extent that the voice (95) is that of a person reading a script, the user (60) may be given the option of selecting from a plurality of readers. For instance, the publisher (50) may present voice samples of various available readers to the user (60) to assist the user (60) in selecting a reader. Alternatively, the publisher (50) may permit users (60) to request an outside party such as a celebrity to read a script.

If the user (60) does not submit a script to be read for voice (95) input (90), one or more scripts may be provided to the user (60) by the publisher (50) and/or prepared by the publisher (50). For instance, a plurality of pre-existing scripts may be presented to the user (60) for selection. Alternatively, a script may be prepared by the publisher (50) based on other inputs (90) provided by the user (60) to the publisher (50), information in the registry (30) associated with the subject or subject item of concern, and/or any other source of information, including combinations thereof. It will also be appreciated that a script may be prepared automatically (e.g., by a script writing program) and/or manually (e.g., by script writing personnel). For instance, the publisher (50) may prepare a script based on a user's responses to one or more questionnaires (91). Where the script is prepared by the publisher (50), the prepared script may be submitted to the user (60) for approval or modification before it is read for voice (95) as input (90). Still other ways in which a script may be prepared and/or presented to a user (60) will be apparent to those of ordinary skill in the art. In yet another embodiment, voice (95) input comprises pre-recorded voice (95), such as one or more “stock” voices (95). It will also be appreciated that voice (95) may easily be combined with other audio, including but not limited to stock music (96) or other music (96). Other ways in which voice (95) may be provided as an input (90) for the publisher (50) will be apparent to those of ordinary skill in the art.

In another embodiment, music (96) may be provided as an input (90) for the publisher (50). For instance, the user (60) may submit music electronically to the publisher (50) via the network (70). Alternatively, music may be received from a user (60) as a hard copy (e.g., on a CD or tape, etc.). Such hard copy music (96) may be entered into the publisher (50) in any suitable way. The publisher (50) may further include a plurality of pre-existing recordings of music (96), and may permit the user (60) to select one or more of such pre-existing recordings of music as an input (90). In this embodiment, the user (60) may be permitted to hear samples of the pre-existing recordings of music (96) to assist the user (60) in the selection process. Of course, the publisher (50) may further include any other “stock audio,” such that stock audio need not necessarily be limited to pre-existing music (96). It will be appreciated that music (96) or the selection of music (96) may be provided as an input (90) for the publisher (50) in any other suitable way.

In yet another embodiment, one or more videos (97) may be provided as an input (90) for the publisher (50). As with images (92), video (97) may be received from a user (60) electronically via the network (70) (e.g., as an AVI file transmitted from the user's computer). Alternatively, video (97) may be received from a user (60) as a hard copy (e.g., as VHS cassette, DVD, etc.). Such hard copy video (97) may be entered into the publisher (50) using any suitable techniques. It will also be appreciated that the publisher (50) may have a plurality of pre-existing videos (97) (e.g., stock video, etc.), such that the user (60) is permitted to select from the pre-existing videos (97). In such an embodiment, the user's selection of pre-existing video (97) may constitute an input (90) into the publisher (50).

While the foregoing discussion of inputs (90) has been made in the context of the publisher (50), it will be appreciated that the registry (30) may also be configured to accept the same types of inputs (90) in any suitable fashion. In other words, regardless of whether the publisher (50) is involved, the registry (30) may be configured to receive any of inputs (90) for information or content relating to subject items having entries in the registry (30). It will also be appreciated that the registry (30) and its contents may be considered as an input (90) for the publisher (50), as may anything stored in storage device (40). In addition, it should be noted that the foregoing inputs (90) are merely exemplary, and that any other type or form of input (98) may be used for the publisher (50) and/or the registry (30).

Regardless of the form of inputs (90), type of inputs (90), source of inputs (90), or method of receiving inputs (90), the publisher (50) of the present example is operable to process at least a portion of the inputs (90) to render any of a variety of outputs (80). The publisher (50) may also use stock information (e.g., stock images, stock sounds, templates, etc.) in the rendering of outputs (80). As noted above, exemplary outputs (80) may include, but need not be limited to, books (81), sound recordings (82), newspaper articles (83), web pages (84), movies (85), prayer cards (86), a collage/montage (87), or any other output (88), including combinations thereof.

The exemplary outputs (80) shown in FIG. 2 are not intended to be exhaustive. Additional outputs (80) may include, but are certainly not limited to, any of the following forms or methods of rendering: podcasts, cell streams, or other data streams; displays on kiosks, such as a kiosk in a cemetery; cable television transmissions; closed circuit transmissions; and/or a variety of printables. Exemplary printables include, but are not limited to, register books (e.g., for funeral attendees to sign upon arriving at a funeral), book markers, bound books, scrapbook content, eulogies, voice over recordings, legal records, heirlooms, professional narrations, or any other output (80) suitable for printing. Still other suitable outputs (80), and methods of rendering and using outputs (80), will be apparent to those of ordinary skill in the art.

As will be described in greater detail below, the publisher (50) may permit users (60) to make a variety of selections relating to the information to be rendered in an output (80), the source(s) of such information, and the form(s) of output (80). The publisher (50) may also give users (60) the opportunity to preview and modify outputs (80) before making a final rendering of outputs (80).

In one embodiment, the publisher (50) is operable to render output (80) in the form of a book (81). For instance, a book (81) may comprise a small, paper booklet having information relating to a deceased person, prayers for the deceased person, tributes to the deceased person, etc. It will be appreciated that copies such a book (81) may be passed out to or among visitors at the deceased person's funeral or in advance of the person's funeral, by way of example only. The book (81) may also include blank portions that may be completed after the book (81) has been printed. For instance, referring back to the example of a funeral, the book (81) may have sections that funeral guests may use to note their attendance at the funeral, provide additional tributes or remembrances, or add any other additional information to the book (81) by hand. Alternatively, a book (81) may be prepared as a eulogy or as a script to be read aloud at a person's funeral.

As another example, a book (81) may comprise an electronic book that is embodied on a CD-ROM, a DVD-ROM, a server, or some other tangible medium. It will thus be appreciated that a book (81) may be downloaded and/or printed by a user (60). Other ways in which a book (81) may be rendered and/or distributed will be apparent to those of ordinary skill in the art.

Regardless of whether a book (81) is rendered on paper, electronically, or otherwise, it will be appreciated that books (81) may vary greatly in terms of content (e.g., information contained within the book (81)), structure (e.g., the arrangement of the content), and form (e.g., aesthetic appearance), in addition to other parameters. The publisher (50) of the present example therefore permits users (60) to make selections as to the content, structure, form, and other parameters of books (81).

In one embodiment, the publisher (50) comprises a biography generator feature. The biography generator of this example is operable to use information received in response to questionnaires (91), in forms (93), or information otherwise received, to automatically write a biography. The biography generated by the biography generator may appear to be written by a human, and may read like a conventional human-written biography. In another variation of the biography generator, the biography generator is configured to write a pseudo-journal that appears to have been written by the person (e.g., a deceased person) that the information relates to. Other suitable styles for written products that may be generated by a biography generator (i.e. other than a biography style or a journal style) will be apparent to those of ordinary skill in the art. In addition, to the extent that a biography generator is operable to prepare written works in a variety of styles, the publisher (50) may permit a user (60) to select a particular style from those available.

Of course, a biography prepared by a biography generator may be incorporated into a book (81) or any other suitable output (80). In implementing a biography generator, it will be appreciated that questions in a questionnaire (91), prompts in a form (93), etc., may correspond with blank portions of a biography template, such that the blanks in the biography template may be automatically filled with the user's responses to the questionnaire (91) and/or form (93). The user's responses may also be subject to some change in form (e.g., response words replaced with synonyms, “species” response terms replaced with corresponding “genus” terms, etc.) before or upon incorporation in a biography template. It will also be appreciated that, where a variety of possible biography templates exist, the user (60) may be permitted to select from the biography templates (e.g., before or after providing responses to a questionnaire (91)). Alternatively or additionally, a biography template may be automatically selected based on some particular input (90) provided by the user (60), information obtained from the registry (30), and/or based on any other criteria.

Exemplary biography templates and template styles may include, but need not be limited to, any of the following: a personality-based form (e.g., Myers-Briggs); chronological form; chaptered per the interests of the person the biography is based on; topical in accordance with aspects of the life of the person the biography is based on; a form inviting future additions or changes (e.g., similar to “Wikipedia” entries); having feminine or masculine tone in accordance with the gender of the person the biography is based on; a form influenced by the geographical location where the person the biography is based on lived (e.g., using a dialect or other geographically-based style aspect); matter-of-fact or embellished style; and/or a narrative script form. Other suitable templates and styles will be apparent to those of ordinary skill in the art. In addition, other possible features of, uses for, and implementations of a biography generator will be apparent to those of ordinary skill in the art.

With respect to the form of books (81), the publisher (50) may include a variety of book (81) templates, each having their own form and/or structure. The publisher (50) may thus permit the user (60) to select a template for a book (81), and further permit the user (60) to select information to be entered into the book (81), and then render the book (81) in accordance with these selections. Book (81) templates may thus be implemented in a manner similar to templates of a biography generator as described above. It will also be appreciated that a book (81) and/or book (81) templates may be customized by a user (60) at least in part manually, or that the same may be customized at least in part automatically, or in some manual/automatic combination. For instance, the publisher (50) may prepare a book (81) automatically, then the user (60) may manually rearrange chapters of the book (81), delete chapters from the book (81), or otherwise modify the automatically produced book (81).

In another embodiment, the publisher (50) may automatically select a book (81) template based on input (90) provided by the user (60) (e.g., certain responses to a questionnaire (91) effect the automatic selection of certain templates). In yet another embodiment, the publisher (50) may request certain input (90) based on a book (81) template selection by a user (60) (e.g., the publisher (50) selects a questionnaire (91) based on a user's book (81) template selection and presents the questionnaire (91) to the user (60) for response). In one example, the publisher (50) includes a Myers-Briggs type of profiler or other profiler, which is configured to pose questions to user (60) in order to discern personality types or other traits. By way of example only, a user (60) may respond to such questions based on their own personal answers, or may answer as if they were a person that the book (81) is about. The traits revealed through use of the profiler may be used by publisher (50) to influence the style or content of a book (81) written by publisher (50). A profiler may also be used to select a template for a biography generator. Other ways in which a profiler component may be used by publisher (50) will be apparent to those of ordinary skill in the art. In addition, it will be appreciated that the publisher (50) may configure a book (81) and/or permit a user (60) to configure a book (81) in any other suitable way.

The publisher (50) of the present example is also operable to produce a sound recording (82) as an output (80) in any suitable format. By way of example only, such a sound recording (82) could comprise any combination of voice (95) and/or music (96). Such voice (95) and/or music (96) may be those that were provided as inputs (90). By way of example only, a sound recording (82) may comprise a voice recording of a person reading a script as described above, regardless of the source of the script or its method of production. For instance, where the publisher (50) includes a biography generator, the sound recording (82) may comprise an audio reading of a generated biography (e.g., the generated biography being used as a script). As with voice (95) input (90) discussed above, the reader(s) of a biography generated by the biography generator may comprise the user (60), a stock reader, a celebrity selected by the user (60), or any other suitable reader(s).

In addition, or in the alternative, a sound recording (82) may comprise stock music and/or voice recordings (e.g., generic music and/or voice recordings retained by the publisher (50) and/or stored in the storage device (40)). As with other outputs (80), the publisher (50) may permit users (60) to configure various aspects of the sound recordings (82). For instance, the publisher (50) may permit users (60) to select the content of a sound recording (82) and/or the arrangement of the content of the sound recording (82).

The publisher (50) may also permit users (60) to select the form of a sound recording (82). For instance, sound recordings (82) may be provided as streaming audio via the Internet, MP3 files downloadable via the Internet, CD's, or in any other form or format. Still other ways in which a user (60) may be permitted to configure a sound recording (82) will be apparent to those of ordinary skill in the art, as will alternative sources for audio in the sound recording (82) and forms/formats of sound recordings (82).

In another embodiment, the publisher (50) is operable to render an output (80) in the form of a newspaper article (83). For instance, the newspaper article (83) may comprise an obituary for a deceased person. Such a newspaper article (83) may be posted on-line, such as at a web site dedicated to such newspaper articles (83), and/or may be rendered in a hard copy (e.g., paper) form. An exemplary method by which the publisher (50) may prepare a newspaper article (83) may include the use of a biography generator feature as described above.

In yet another embodiment, the publisher (50) is in electronic communication with newspaper bureaus, such that the publisher (50) may automatically transmit a newspaper article (83) to the appropriate newspaper bureau(s) for publication of the newspaper article (83) in the newspaper(s) of such bureau(s). In this embodiment, the publisher (50) may be configured to automatically determine the appropriate newspaper bureau(s) to communicate the newspaper article (83) to. For instance, where the newspaper article (83) comprises an obituary for a deceased person related to the user (60), the publisher (50) may gather and process location information regarding the user's residence, the deceased person's residence, the final resting place of the deceased person, etc. in order to determine the proper newspaper bureau(s) for communicating the obituary newspaper article (83) to. In addition, or in the alternative, the publisher (50) may permit the user (60) to select one or more newspaper bureau(s) for communicating the obituary newspaper article (83) to. Still other ways in which newspaper articles (83) may be created, provided, and transmitted will be apparent to those of ordinary skill in the art.

In yet another embodiment, the publisher (50) is operable to create one or more web pages (84) as an output (80) in any suitable format. For instance, the publisher (50) may be operable to automatically create a web site comprising a plurality of web pages (84) as an output (80). It will be appreciated that such web pages (84) may be placed in and accessible through the registry (30). In other words, where the registry (30) comprises a plurality of web pages dedicated to particular subject items as described above, at least a portion of those web pages may be web pages (84) that are an output (80) of the publisher (50). Alternatively, the web pages (84) that are created as an output (80) of the publisher (50) may be separate from the registry (30). The content of the web pages (84) may be based on any information, including but not limited to one or more inputs (90), information/content in the registry (30), stock information/content, or any other information/content, including combinations thereof. It will be appreciated that there are a variety of alternative ways in which web pages (84) may be produced as an output (80) of the publisher (50).

The publisher (50) may also create a movie (85) as an output (80) in any suitable format. As used herein, the term “movie” shall be read to include any series of images, including but not limited to video and slideshows, regardless of form, format, or medium. In one embodiment, a movie (85) comprises a sequence of images (92) that were provided as an input (90) to the publisher (50). For instance, a movie (85) may comprise a slideshow of images (92), and may further be accompanied by any number of voice (95) inputs (90) and/or music (96). In addition, or in the alternative, such a movie may comprise one or more videos (97), one or more voices (95), music (96), any other inputs (90) provided to the publisher (50), information/content from the registry (30), stock information/content, and/or any other information/content.

To the extent that a movie (85) has one or more sound components (e.g., voice (96), music (96), sound recording (82), etc.), such sound components may be synchronized with visual aspects of the movie (85). By way of example only, where a movie (85) comprises a slideshow of images (92), each sound component may serve as an audio caption or accompaniment for one or more corresponding images (92) in the slideshow. In another embodiment, a biography generator is used to prepare a script, which is read as a voice (95) input (90) and used as a voice-over for a movie (85). In yet another embodiment, a voice (95) input (90) is used for narration in a movie (85). Alternatively, sound components may be integrated into a movie (85) at random. Other suitable configurations of sound components for movies (85), including alternative relationships between sound components and visual components of a movie (85), will be apparent to those of ordinary skill in the art.

The publisher (50) may further comprise a feature that permits users (60) to construct the movie (85) (e.g., in terms of content and arrangement). Alternatively, the publisher (50) may create the movie (85) automatically. It will also be appreciated that movies (85) may be provided to users (60) in a variety of forms, including but not limited to streaming video, video that is downloadable from a web site (e.g., as an AVI file), video on a CD or DVD, or any other form. Suitable formats for a movie (85) may include, but need not be limited to, Macromedia/Flash, MPEG, Real, AVI, Quicktime, WMV, ASF, or any other format. It will also be appreciated that a movie (85) may be provided in any suitable genre or style, including but not limited to documentary style. Still other variations of a movie (85) as an output (80) of the publisher (50) will be apparent to those of ordinary skill in the art.

In another embodiment, the publisher (50) is operable to create one or more prayer cards (86) as an output (80). Such prayer cards (86) may be created, varied, and used in all manners described above with respect to a book (81) as an output (80) of the publisher (50). The publisher (50) may also comprise a selection of various stock prayers that users (60) may review and select from for inclusion in a prayer card (86) or any other printable, along with a variety of other stock information/content (e.g., templates, images, etc.). Stock prayers need not necessarily be limited to pre-existing prayers, and may include wise or famous quotations from any source, sayings, proverbs, etc. The publisher (50) may also permit users (60) to submit their own prayers as an other (98) input (90) for inclusion in a prayer card (86). Of course, any other inputs (90) may be incorporated into a prayer card (86). It will also be appreciated that the creation and production of prayer cards (86) as an output (80) of the publisher (50) may be varied in any suitable way.

The publisher (50) may also be operable to create a collage or montage (87) as an output (80). As used herein, the term “collage” should be read to include a combination of static visual elements. For instance, a collage (87) may comprise a combination of static images (92), documents (94), and the like. As used herein, the term “montage” shall be read to include a combination of dynamic elements or a combination of static elements with dynamic elements. For instance, a montage (87) may comprise a combination of any of the following: images (92), documents (94), voice (95), music (96), and/or video (97) and the like. It will therefore be appreciated that some conceptual overlap may exist with respect to a montage (87), a sound recording (82), and/or a movie (85), among other possible forms of output (80).

It will also be appreciated that, in addition to or as an alternative to inputs (90), information/content from the registry (30), stock information/content, and/or any other information/content may be used to produce a collage or montage (87). Furthermore, the construction of a collage or montage (97) may be subject to any suitable level of automation and/or user (60) preference. For instance, the user (60) may be permitted to select the components of the collage or montage (97), the source(s) of such components, the arrangement of the components, the form of the collage or montage (97), and/or the method of delivery. Other suitable collage or montage (97) features and variations will be apparent to those of ordinary skill in the art.

While several exemplary multimedia outputs (80) have been described above, it should be noted that a variety of other outputs (88) may be produced by the publisher (50). It should also be noted that any of the foregoing outputs (80) may be varied, modified, substituted, or supplemented in any suitable way.

Furthermore, it will be appreciated that any of inputs (90) or other information/content may undergo any number of changes in form while being processed by the publisher (50) to render an output (80). For instance, a voice (95) input (90) may be converted to text (e.g., manually or automatically) during the production of a book (81), a newspaper article (83), a web page (84), a prayer card (86), and/or any other (88) output (80). Similarly, text that is provided in an input (90) (e.g., responses to a questionnaire (91), responses in a form (93), text in a document (94), etc.) may be converted to voice during the production of a sound recording (82), movie (85), montage (87), and/or any other (88) output (80). Of course, a variety of other changes in form may occur.

It will also be appreciated that a plurality of types of outputs (80) may be combined in a single output (80). For instance, the publisher (50) may create a sound recording (82) that is combined with a movie (85) as a soundtrack to the movie (85). As another merely illustrative example, a book (81) and/or collage (87) may be posted on a web page (84) created by the publisher (50). Similarly, a web page (84) created by the publisher (50) may include hyperlinks to other outputs (80), permit the downloading of other outputs (80), or may otherwise incorporate or be associated with other outputs (80). For instance, a web page (84) created by the publisher (50) may permit users (60) to view a streaming movie (85) through the web page (84). Where a plurality of constituent outputs (80) are combined to form a single output (80), the constituent outputs (80), and optionally the single output (80), may be produced simultaneously or in any suitable sequence. Other suitable output (80) combinations and methods for producing the same will be apparent to those of ordinary skill in the art.

It will also be appreciated that, in some situations, an output (80) may be fed back through the publisher (50) as an input (90). For instance, the publisher (50) may create a book (81) as an output (81) (e.g., using an automated biography generator); then have the book (81) read aloud as a script for a voice (95) input (90); then produce a sound recording (82) as an output (81) incorporating that voice (95). In this example, the book (81) may be regarded as a “feedback input” due to its use during the provision of the voice (95) as an input (90). As another example of feedback input (90), the publisher (50) may create a plurality of movies (85), then use at least a portion of those movies (85) as video (97) inputs (90) to create a montage (87). Other suitable methods for using outputs (80) as feedback inputs (90) will be apparent to those of ordinary skill in the art. Furthermore, it will be appreciated that even if an output (80) used as a feedback input (90), that output (80) may still be provided to the user (60) in addition to the subsequent output (80) that incorporates the feedback input (90).

As noted above, a user's selection of output (80) type and/or form may also require a particular type of input (90). For instance, the publisher (50) may be configured such that, in order to render a book (81) as an output (80), the publisher (50) needs answers to certain questions in a questionnaire (91) (e.g., in accordance with a selected book template). Similarly, the publisher (50) may be configured such that, in order to render a sound recording (82) as an output (80), the publisher (50) needs at least one of a voice (95) or music (96) input (90). It will therefore be appreciated that the selection of an output (80) may occur before any input (90) is provided. To the extent that a particular type of input (90) is required in order for the publisher (50) to render a selected output (80), the publisher (50) may be configured to prompt or request the user (60) for such necessary input (90). Alternatively, the publisher (50) may suggest an alternative output (80) that may be rendered based on inputs (90) that have already been provided or information/content that the publisher (50) already has access to.

In the present example, the publisher (50) comprises a computer program. It will therefore be appreciated that processes employed by the publisher (50) may be automated to any suitable degree, including but not limited to the rendering of outputs (80). Of course, the processes employed by the publisher (50) may also include any number of manual steps (e.g., steps performed by a human), including but not limited to configuration of preferences relating to publisher (50), configuration of outputs (80), review of outputs (80), etc. In the present example, the publisher (50) resides on a server remote from the user (60). It will therefore be appreciated that the publisher (50) may be executed on such a server. Alternatively, the publisher (50) may be downloaded by a user (60) and executed locally on the user's computer system. Of course, the publisher (50) may also be executed locally (e.g., on the user's computer system) in part and remotely (e.g., on a server) in part. Other suitable software configurations for the publisher (50) will be apparent to those of ordinary skill in the art.

It will also be appreciated that there are a variety of possible relationships between the registry (30) and the publisher (50), including but not limited to various ways in which the publisher (50) may interface with the registry (30). For instance, a given input (90) and/or output (80) of the publisher (50) may be related to any subject item having an entry in the registry (30). In the present example, the registry (30) includes entries relating to a plurality of deceased persons, and each output (80) of the publisher (50) relates to at least one of those deceased persons. Of course, just as the registry (30) may comprise entries relating to a variety of subject items other than deceased persons, the publisher (50) may render outputs (80) relating to a variety of subject items other than deceased persons.

In addition, in the present example, the registry (30) and the publisher (50) comprise separate computer programs that are in electronic communication with each other. It will therefore be appreciated that the registry (30) and the publisher (50) may reside on separate servers. Alternatively, the registry (30) and the publisher (50) may reside on the same server. Similarly, the publisher (50) may be considered as and presented as a feature of the registry (30). Likewise, the registry (30) may be considered as and presented as a feature of the publisher (50). The registry (30) and the publisher (50) may also be considered as a single integrated program or service. Other relative configurations of the registry (30) and the publisher (50) may be used.

In the present example, the registry (30) and the publisher (50) are in electronic communication with each other via a network. It will be appreciated that such communication may be provided in a variety of ways. For instance, the communication may be one-way or two-way. It will also be appreciated that an entry for a given subject item in the registry (30) may include a hyperlink to an electronic output (90) of the publisher (50) that relates to the subject item. For instance, a web page in the registry (30) for a deceased person may include a hyperlink permitting users (60) to download a movie (85) produced by the publisher (50) that relates to the deceased person. Similarly, the publisher (50) and/or certain outputs (80) of the publisher (50), may include a hyperlink to an entry to a related subject item in the registry (30). Of course, while the term “hyperlink” is used in this example, it will be appreciated that the use of such term does not indicate an intent that the implementation be limited to the Internet, the world wide web, or otherwise. Any other link or similar device may be used.

Alternatively, an output (80) of the publisher (50) may simply indicate that a registry (30) entry exists for a subject item to which the output (80) relates. Still other suitable relationships between the registry (30) and the publisher (50), including but not limited to relationships between entries in the registry (30) and outputs (80) of the publisher (50), will be apparent to those of ordinary skill in the art.

Where both user(s) (60) and provider(s) (62) use the system (10), such use may be divided or shared in any suitable fashion, and a user (60) or provider (62) may play any of a number of roles. For instance, a provider (62) may employ or contract with stock readers or voice talent for reading scripts for voice (95) as input (90) into the publisher (50). Similarly, if a user (60) selects an outside party such as a celebrity to read a script for voice (95) input (90) into the publisher (50), the provider (62) may assume responsibility for making arrangements with the celebrity. To the extent that an output (80) of the publisher (50) comprises a tangible object (e.g., a hard copy book (81), a DVD movie (85), etc.), the provider (62) may assume responsibility for producing such objects. Alternatively, the user (60) may assume such responsibility, and may receive from the publisher (50) whatever is necessary to accomplish such production. In addition, information relating to a subject or subject item in the registry (30) and/or inputs (90) into the publisher (50) may be entered into the system (10) by a user (60). Alternatively, the user (60) may provide such information or materials to the provider (62), and the provider (62) may enter the same into the system (10). To the extent that an output (80) is provided as a promotion in connection with the sale of some other goods or services, the provider (62) may also provide such goods or services to users (60). Alternatively, the provider (62) may contract with the providers of such goods or services to effect the promotion. Other possible relationships between users (60), providers (62), and the system (10) will be apparent to those of ordinary skill in the art.

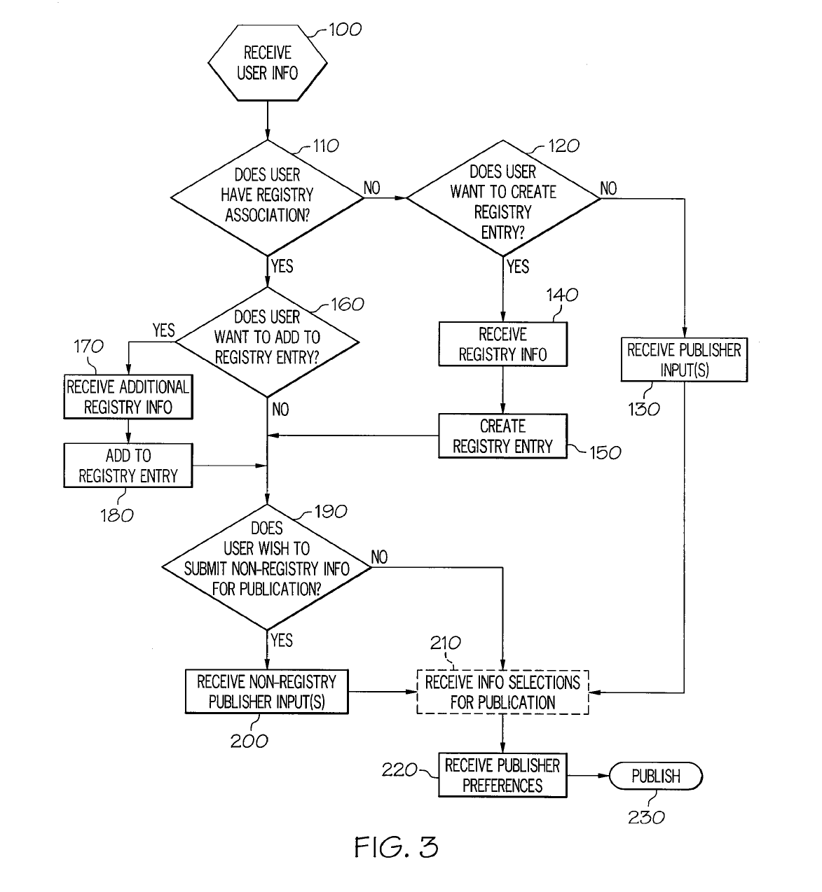

FIG. 3 depicts an exemplary set of steps for gathering and publishing information using the system (10). In block (100), information about the user (60) is received. Such information may include identifying information about the user (60). For instance, the identifying information may include a username and a password. If the user (60) lacks a username and password, the user (60) may create the same. Alternatively, the information received in block (100) may be associated with an entity or other subject item having an entry in the registry (30). In yet another embodiment, the information received in block (100) may be associated with an entity or other subject item lacking an entry in the registry (30).

In block (110), the system (10) determines whether the user (60) has a registry (30) association, based on the information submitted by the user (60) in block (100). It will be appreciated that a user (60) may have a registry (30) association in a variety of ways. For instance, an entry may exist in the registry (30) that includes information (e.g., biographical information) relating to the user (60). Alternatively, an entry may exist in the registry (30) that includes information relating to a person or other entity with whom the user (60) is associated (e.g., the user (60) is a friend or relative of a person having a registry (30) entry). Still other ways in which a user (60) may have a registry (30) association will be apparent to those of ordinary skill in the art.

If the system (10) determines in block (110) that the user (60) does not have a registry (30) association, the system (10) of the present example proceeds to block (120), where it determines whether the user (60) would like to create a new registry (30) entry or whether the user (60) would like to create an association between the user (60) and an existing registry entry (30). This determination may be made simply by asking the user (60) via a prompt or other device. Alternatively, this step (or any other step) may be omitted or varied.

If the user (60) indicates that he/she does not wish to create a registry (30) entry in block (120), the system (10) may permit the user (60) to submit information for publication. Such information may include any of the types of inputs (90) described above with respect to FIG. 2, or any other type of information and/or techniques for submitting information. In the present example, after receiving publisher input(s) (90), as shown in block (130), the system (10) may proceed to block (210), which will be described in further detail below.

If the user (60) indicates a desire to create a registry (30) entry in block (120), the system (10) may then receive registry (30) information (e.g., biographical information relating to a deceased friend or relative of the user (60)), as shown in block (140), and create a registry (30) entry in accordance with the same, as shown in block (150). The system (10) may then proceed to block (190), which will be described in greater detail below.

If the system (10) determines in block (110) that the user (60) has a registry (30) association, the system may provide the user (60) an opportunity to add additional information to the registry (30) entry with which the user (60) is associated. Such an opportunity may be provided by prompting the user (60) for such additional information as shown in block (160). If the user (60) does not wish to add information to the registry (30) entry, the system (10) may proceed to block (190), which will be described in further detail below. If, however, the user (60) has additional information for submission to the registry (30) and wishes to submit the same, the system (10) may receive the additional information as shown in block (170) and add the information to the registry (30) entry as shown in block (180). After adding the additional information to the registry (30), the system (10) may proceed to block (190).

In block (190), the system (10) may determine whether the user (60) wishes to submit non-registry information for publication, such as by prompting the user (60). Such non-registry information may comprise any inputs (90) described above, and may be information that the user (60) wishes to have in the publication but not in the registry (10) entry; or may be information that is otherwise non-registry information. If the user (60) wishes to submit non-registry input(s) (90), the system (10) may receive the same as shown in block (200), then proceed to block (210). If the user (60) does not wish to submit non-registry information, the system (10) may proceed directly to block (210).

Upon reaching block (210), the system (10) of the present example will have all of the publication content it needs for publication. Such information may comprise information existing in a registry (30) entry prior to block (100), information submitted in blocks (130, 140, 170, and/or 200), and/or stock information, etc. As used herein, the term “stock information” includes information that has no particular pre-existing association with the user (60), and is accessible to all users (60) or a group of users (60). Examples of stock information include, but are not limited to poems, prayers, music, images, graphics, quotations, and the like. In block (210), the user (60) is permitted to select information from the available information for publication. Such selection may be provided in a variety of ways. For instance, at least a portion of the available information may be categorized, such as by type or format, and the user (60) may be permitted to select among categories of information to be published. In addition or in the alternative, the user (60) may be permitted to select pieces of content and/or media individually (e.g., select individual images, etc.). Still other ways in which a user (60) may be permitted to make information selections will be apparent to those of ordinary skill in the art.

In another embodiment of block (210), the system (10) automatically selects information to be published. Such automatic selection may be effected through any suitable process. For instance, automatic selection may include a purely randomized selection of information. Alternatively, automatic selection may include the use of a basic template having information type categories, with random selection of available information for insertion into the template. Of course, a variety of templates may be provided, and a user (60) may be permitted to select a template in block (210), with the template being filled with information automatically and/or manually by the user (60). Other ways in which automatic selection of information may be provided will be apparent to those of ordinary skill in the art. In yet another embodiment, block (210) is incorporated into block (220), which will be described below.

In block (220), the user (60) is prompted to enter publisher preferences. Such publisher preferences may include the type of output (80). Where a given type of output (80) may be rendered in various forms, publisher preferences may further include an indication of the desired form of output (80). For instance, a user (60) may select a book (81) as the type of output (80) in block (220). Yet there may be a variety of forms in which a book (81) or other output (80) may be provided (e.g., varying color schemes, themes, templates, etc.). The user (60) may thus also make selections relating to the form of book (81) or other output (80) in block (220).

Publisher preferences may also include delivery method. For instance, a user (60) may select delivery of a book (81) via regular mail, via e-mail, via download from the Internet, via distribution at a funeral, to a book publisher, via any other method, or to any other destination, including combinations thereof. Still other publisher preferences will be apparent to those of ordinary skill in the art.

In addition, it will be appreciated that the information selection, which may otherwise be done “manually” in block (210), may be automated based on publisher preferences selected in block (220). For instance, publisher preferences received in block (220) may indicate a particular type of output (80) into which a limited number of, forms of, or types of inputs (90) may be incorporated. In this example, the system (10) may be configured to automatically select the information and/or inputs (90) to incorporate into an output (80). In one embodiment, usable information is automatically selected at random. In another embodiment, all usable information is automatically selected. Other ways in which information may be automatically selected will be apparent to those of ordinary skill in the art.

In yet another embodiment, the order of blocks (210 and 220) is reversed. In other words, a user (60) may indicate publisher preferences prior to selecting information for publication. It will be appreciated that publisher preferences may be used to limit the availability of information for selection by the user (60). For instance, if the user (60) indicates in block (220) that a hard copy book is desired, the system may prevent the user (60) from selecting music (96) as a type of information to be included within the publication. To restrict availability of certain types of information, the system (10) may present to the user (60) a listing of available information that is limited based upon publication selections made by the user (60). Alternatively, the system (10) may prompt a user (60) to either remove unusable selected information or modify their publication selections when the information selections and publisher preferences of the user (60) are somehow inconsistent or incompatible. Of course, consistency and compatibility of information selections and publisher preferences may be handled in any other suitable way.

In the present example, with information selections and publisher preferences having been indicated, the system (10) publishes as indicated in block (230). It will be appreciated that this act of publication (230) may comprise rendering any of the outputs (80) by the publisher (50).

The foregoing steps may be performed in any suitable order, and any of the steps may be varied, eliminated, substituted, or supplemented. It will also be appreciated that all of the examples discussed herein are merely illustrative, and are not intended to be limiting in any way.

To the extent that a provider (62) earns revenue for providing a system (10), it will be appreciated that there are a variety of ways in which money may be collected from users (60) or other persons/entities. For instance, a provider (62) may charge users (60) a periodic (e.g., monthly) fee for maintaining entries in the registry (30). Such a fee may be based on the number of entries a user (60) has created or submitted information to on the registry (30). Alternatively, users (60) may be charged a single “signup” fee for the registry (30). Similarly, a provider (62) may charge users (60) any type of fee for use of the publisher (50). For instance, the provider (62) may charge users (60) for each output (80) rendered by the publisher (50).

In another embodiment, users (60) are not always charged directly for use of the publisher (50), and use of the publisher (50) is permitted, and/or outputs (80) are provided, based upon the purchase of something else. For instance, the registry (30) may include a signup fee, and a user (60) may be given any number of “free” publications or outputs (80) for signing up with the registry (30). It will therefore be appreciated that users (60) may be given an output (80) as part of a promotion.

In another example, a promotion may couple a free output (80) with the purchase of an item or service that is related to the output (80). For instance, an entity may sell a vacation package (e.g., a cruise), and provide, free of charge, a book (81) and/or movie (85), etc. from the publisher (50) to purchasers of the vacation package. In this example, the book (81) and/or movie (85) may include images (92) and/or other content that relates to the purchasers' vacation. As another example, a seller of wedding rings may provide, free of charge, a book (81), movie (85), or some other output (80) as a promotion for the purchase of wedding rings. In this example, the book (81) and/or movie (85), etc., may include images (92) and/or other content that relates to the purchasers' wedding. Still other ways in which outputs (80) may be provided on a promotional basis will be apparent to those of ordinary skill in the art.

As yet another example, the publisher (50) may be associated with an affinity membership program. For instance, a user (60) may be a member of a particular club having an association with a publisher (50), and that club may provide the user (60) the opportunity to interact with the publisher (50) as a benefit of club membership. The club may also use a publisher (50) to produce outputs (80) relating to the club. Inputs (90) may be provided by the club and/or by the member of the club. Similarly, the club may be the user (60) of the publisher (50), and/or the member of the club may be the user (60) of the publisher (50). Alternatively, a publisher (50) may be implemented in an affinity membership program or club in any other suitable way.

In still another example, a publisher (50) may be implemented as part of a customer loyalty program. For instance, an airline or travel agency may provide a “frequent filer” program or similar program, and may offer customers one or more outputs (80) of a publisher (50), free of charge, when a certain amount of “frequent flier miles” have been garnered by a customer. The one or more free outputs (80) may be based upon the customer's travels through the airline or travel agency. The airline or travel agency may also permit the customer to provide inputs (90) for a publisher (50), as the customer travels to destinations through the airline or travel agency, when the predetermined number of frequent flier miles have been garnered by the customer, and/or at any other suitable time. For instance, a customer of a travel agency may provide images (92) captured during the customer's vacation that was facilitated by the travel agency, and the customer may further provide answers to a questionnaire (91) based upon the vacation. The images (92) and responses to the questionnaire (91) may be processed through the publisher (50) by the customer and/or by the travel agency, subject to publication preference selections by the customer and/or by the travel agency.

Of course, the “frequent flier miles” example is merely illustrative, and an entity may offer a free or discounted output (80) to one or more customers of the entity when some other milestone of the entity-customer relationship is reached, or based on any other criteria. Similarly, inputs (90) and outputs (80) provided through a customer loyalty program may be related to the entity-customer relationship in any suitable way, or may be unrelated to such relationship. Still other ways of implementing a publisher (50) as part of a customer loyalty program will be apparent to those of ordinary skill in the art.

Having shown and described various embodiments and concepts of the invention, further adaptations of the methods and systems described herein can be accomplished by appropriate modifications by one of ordinary skill in the art without departing from the scope of the invention. Several of such potential alternatives, modifications, and variations have been mentioned, and others will be apparent to those skilled in the art in light of the foregoing teachings. Accordingly, the invention is intended to embrace all such alternatives, modifications and variations as may fall within the spirit and scope of the appended claims and is understood not to be limited to the details of structure and operation shown and described in the specification and drawings.

1. A method of producing a biographical writing, the method comprising:
(a) initiating a profiler to pose one or more questions to a user about the user or a deceased person associated with the user;
(b) receiving one or more responses to the one or more questions from the user, wherein the one or more responses are about the user or the deceased person associated with the user;
(c) selecting a plurality of template options to provide to the user, wherein the act of selecting template options comprises:
i. analyzing the one or more responses from the user to determine one or more personality traits of the user or the deceased person associated with the user, and
ii. comparing the one or more personality traits to one or more template options;
(d) providing the plurality of template options to the user;
(e) receiving a template selection from the user;
(f) requesting biographical information from the user, wherein the requested biographical information relates to the deceased person associated with the user, wherein the requested biographical information is usable as content for an automatically generated biography;
(g) receiving from the user the biographical information relating to the deceased person associated with the user; and
(h) automatically generating a biographical text using the template selection from the user with the content of the biographical information provided by the user relating to the deceased person associated with the user.

2. The method of claim 1 wherein the step of initiating a profiler comprises initiating a Myers-Briggs profiler.

3. The method of claim 1 wherein the step of receiving a template selection is performed before the step of requesting the biographical information relating to the deceased person associated with the user, wherein the requested biographical information is based on the received template selection.

4. The method of claim 1 wherein the step of receiving a template selection comprises automatically selecting a template from the plurality of templates based on the one or more responses from the user to the one or more questions posed by the profiler.

5. The method of claim 1 wherein the received biographical information comprises an audio tribute to the deceased person associated with the user.

6. The method of claim 5 wherein the act of automatically generating a biographical text comprises converting at least a portion of the audio tribute to text.

7. The method of claim 5 wherein the audio tribute comprises audio recorded at a funeral for the deceased person associated with the user.

8. The method of claim 1 wherein the step of requesting biographical information from the user comprises presenting a first questionnaire having one or more questions pertaining to biological information about the deceased person associated with the user, and wherein the step of receiving from the user the biographical information relating to the deceased person associated with the user comprises receiving one or more responses to the one or more questions of the first questionnaire.

9. The method of claim 8 further comprising the step of presenting a second questionnaire having one or more questions pertaining to biological information about the deceased person associated with the user, wherein the step of presenting a second questionnaire is based, at least in part, on one of the one or more responses to the one or more questions of the first questionnaire.

10. The method of claim 8 wherein the first questionnaire is selected by the user from a plurality of questionnaires.

11. The method of claim 8 wherein the first questionnaire is selected at random from a plurality of questionnaires.

12. The method of claim 8 wherein the step of receiving a template selection is performed before the step of requesting the biographical information relating to the deceased person associated with the user, wherein the first questionnaire is based on the received template selection.

13. The method of claim 1 wherein the step of automatically generating a biographical text comprises inserting content into the template selection that is not biographical information provided by the user relating to the deceased person associated with the user.

14. The method of claim 1 wherein the biographical text comprises a pseudo journal writing style written in first person.

15. The method of claim 1 comprising producing one or more of a book or a prayer card comprising the biographical text.

16. A method of publishing, the method comprising:
(a) receiving inputs from a user, wherein at least one of the inputs comprises content selected from the group consisting of audio, imagery, and text;
(b) storing at least a portion of the received inputs in a storage medium;
(c) initiating a profiler to pose questions to the user about the user or a deceased person associated with the user;
(d) receiving responses to the questions from the user, wherein the responses are about the user or the deceased person associated with the user;
(e) selecting a template option from a plurality of template options, wherein the step of selecting a template option from the plurality of template options comprises:
i. analyzing the responses from the user to determine one or more personality traits of the user or the deceased person associated with the user,
ii. comparing the one or more personality traits to the plurality of template options, and
iii. selecting a template option from the plurality of template options based upon the comparison of the one or more personality traits to the plurality of template options;
(f) processing the received inputs and the selected template option, wherein the step of processing comprises automatically generating a writing based on the received inputs and the selected template option; and
(g) providing the generated writing in a tangible medium.

17. The method of claim 16 wherein the writing comprises a biographical text.

18. The method of claim 16 comprising the step of receiving user modifications to the generated writing.

19. The method of claim 16 wherein the generated writing in a tangible medium comprises one or more blank portions.

20. A method comprising:
(a) accessing a registry, wherein the registry comprises information relating to a plurality of subjects;
(b) receiving inputs, wherein at least a portion of the received inputs comprises information received from the registry pertaining to a select one of the plurality of subjects;
(c) initiating a profiler to pose questions to a user about the user or the select one of the plurality of subjects;
(d) receiving responses to the questions from the user, wherein the responses are about the user or the select one of the plurality of subjects;
(e) selecting a plurality of template options to provide to the user, wherein the act of selecting template options comprises:
i. analyzing the responses from the user to determine one or more personality traits of the user or the select one of the plurality of subjects, and
ii. comparing the one or more personality traits to one or more template options;
(f) providing the plurality of template options to the user;
(g) receiving a template selection from the user; and
(h) automatically generating a writing using the template selection from the user with the received inputs.
